(19) United States
(12) Patent Application Publication
(10) Pub. No.: US 2019/0340485 A1
(43) Pub. Date: Nov. 7, 2019

(54) METHOD AND SYSTEM FOR GENERATING A RESPONSIVE COMMUNICATION FROM A CHATBOT TO NETWORK WITH PLANT MONITORING SYSTEMS

(71) Applicants: Phuc Ngo, San Jose, CA (US); Kris Le, San Jose, CA (US); Vidyadhar Handragal, San Jose, CA (US); Kanaad Pathak, Bangalore (IN)

(72) Inventors: Phuc Ngo, San Jose, CA (US); Kris Le, San Jose, CA (US); Vidyadhar Handragal, San Jose, CA (US); Kanaad Pathak, Bangalore (IN)

(21) Appl. No.: 15/973,481

(22) Filed: May 7, 2018

(51) Int. Cl. G06N 3/00; G06N 99/00; G06F 17/28; H04L 12/58; A01G 7/00

(52) U.S. Cl. CPC G06N 3/006; G06N 99/005; H04L 67/12; H04L 51/02; A01G 7/00; G06F 17/28

(57) ABSTRACT

A plant monitoring system includes one or more internet of things (IOT) sensors to detect conditions associated with a plant; a database coupled to the sensors; and a chatbot coupled to the database to answer queries from a user about the plant condition.

### BACKGROUND

IoT is defined as a network of physical devices, equipment and other items embedded with electronics, software, sensors, actuators, and connectivity which enables these objects to connect and exchange data. In relation to the plant growth parameters, there will be a wealth of information or data that gets digitally exchanged & stored within the database. This database can be used to generate reports or information via analytics that aid the grower to understand the parameters that contribute to healthy plant growth and also to keep a check and control on parameters that can have an adverse impact on the plant growth. With time, this information can aid future planning to enhance plant or crop productivity. Chatbots as a conversational partner act as a very useful tool to present the above historical information at any stage of the growth cycle to the growers, the staff supporting the grower & also aiding the customers of the growers or growers producing further value-add producers.

In a parallel trend, chatbots as a communication medium, are becoming increasingly popular as an exciting and collaborative medium for the providing information related to a specific subject or a set of multiple subjects. Traditionally this collaborative medium comprised of customer service agents handling the information or a text-based FAQ (frequently asked questions) section hosted on a website or printed in various product or services manuals.

A chatbot is a computer program which conducts a conversation via auditory or textual methods. Such programs are often designed to convincingly simulate how a human would behave as a conversational partner, thereby passing the Turing test. Chatbots are typically used in dialog systems for various practical purposes including customer service or information acquisition. Some chatbots use sophisticated natural language processing systems, but many simpler systems scan for keywords within the input, then pull a reply with the most matching keywords, or the most similar wording pattern, from a database. The disclosed embodiments take a different approach and describe an application that is specific to IOT plant monitoring and how the chatbot can have insights from previous data that is not NL (natural language) based.

In a simple example, a chatbot may replace a text-based FAQ (frequently asked questions) facility on a web site. FAQ facilities generally provide a list of frequently asked questions and invite a correspondent to select one of them. Then the correspondent is automatically presented an answer. While this serves the purpose of conveying information, it is dull.

By contrast, a chatbot provides a conversational experience for interaction with correspondents. The correspondent can type a question and the chatbot will attempt to interpret it, and then provide an answer. In the context of a frequently asked question (FAQ) facility, if the correspondent submits one of the frequently asked questions using words the same as or similar to the question, typically the chatbot will provide the prepared text answer; exactly like the text-based facility but in the context of chat.

Most previous chatbots operate in this way. The answer they present is a simple answer to a known question. If the question is unknown, the chatbot simply offers a list of FAQ, and invites the correspondent to select one. A significant problem with the use of most chatbots is the time it takes to program one. It typically takes months of programming and many hundreds of thousands of dollars for a user to create a workable chatbot.

Retrieval based chatbots require a lot of programming in the form of “if-then” statements. However, using a Deep Learning NLP layer reduces the amount of pre-processing required for natural language processing. While working with domain specific chatbots, we don't have to worry about programming in the context of the question every time we want to switch the domain of the system.

### SUMMARY

In one aspect, a plant monitoring system includes one or more internet of things (IOT) sensors to detect conditions associated with a plant; a database coupled to the sensors; and a chatbot coupled to the database to answer queries from a user about the plant condition.

In another aspect, a method to identify plant growth conditions includes providing an internet of thing (IOT) connected sensor to capture one or more plant conditions; communicating the plant conditions to a remote data storage device to store current and previous local data independent of outside sources; receiving a user inquiry about the plant condition in a natural language; providing the query to a chatbot; and answering the query using the chatbot.

In yet another aspect, a method is disclosed for interacting with a IoT based plant monitoring system. The application can fetch vital parameters from the system and allow the user to interact with the system in a natural language. The system is an add on module to an existing app that already provides all the vital parameters to the user, except instead of the user having to make sense of the information provided by the sensors, system decomposes the values and provides a user-friendly response to each question. The system can also recommend, based on previous learning, how to set up the optimal plant conditions if it detects that readings that it feels project inadequate plant growth.

Advantages of the system may include one or more of the following. By instantaneously analyzing a customer's prior communications and leveraging real-time linguistic analysis, the system could personalize Al communication for customers via online chat screens, in automated contact centers, through voice enabled devices and even with video formats. In addition to learning from the numeric data specific to a IOT device, the system can also make suggestions for optimal growth. This type of system can also give general question answers to frequently asked user questions about the state of the system. The model developed in this system can also connect to various voice enabled devices like Google Home or Amazon Alexa to feed and retrieve information from the IoT device database. The chatbot scales across readings from multiple IOT devices and can intelligently decompose the data from all the devices to make future predictions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an exemplary system for interacting with an IOT-based plant monitoring system.

FIG. 2 shows exemplary Growth Parameters representation in the information database.

FIGS. 3A-3B show an exemplary learning machine to detect conditions of a plant and to recommend actions for the plant.

FIG. 4 shows an exemplary chatbot embodiment.

### DESCRIPTION

The invention now will be described more fully hereinafter with reference to the accompanying drawings, in which some, but not all embodiments of the invention is shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The disclosed application provides a method for interacting with a IoT based plant monitoring system. The application can fetch vital parameters from the system and allow the user to interact with the system in natural language. The system is an add on module to an existing app that already provides all the vital parameters to the user, except instead of the user having to make sense of the information provided by the sensors, we can ask the system to decompose the values and make sense of it. The system can also recommend based on previous learning how to set up the optimal conditions if it detects that readings that it feels project inadequate plant growth.

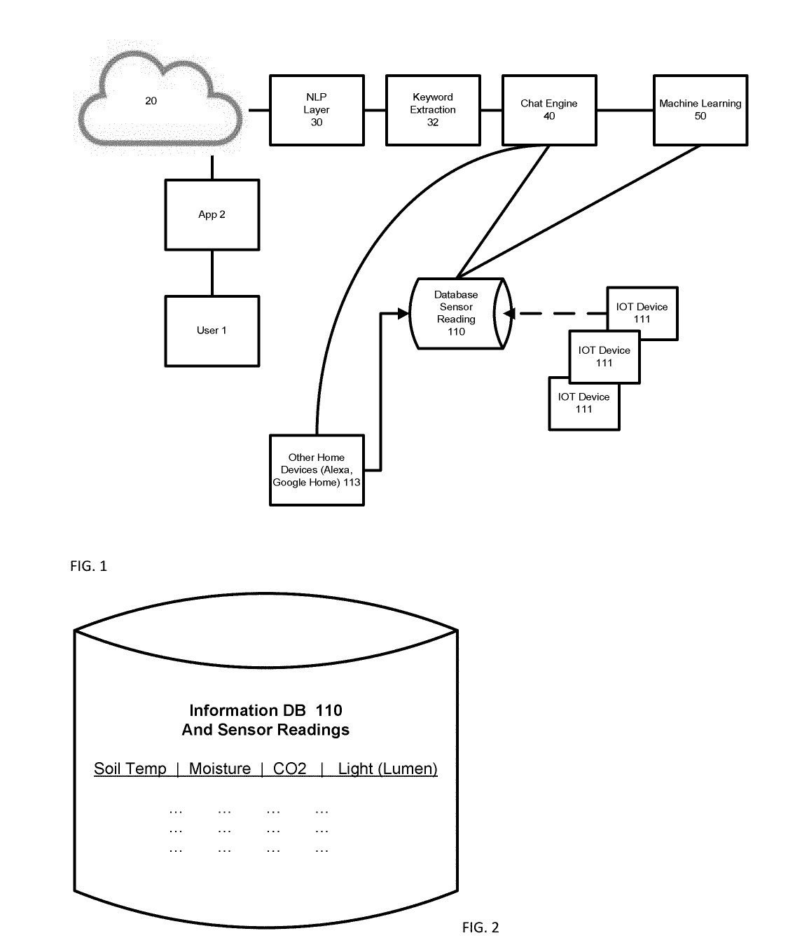

FIG. 1 shows an exemplary system for interacting with an IOT-based plant monitoring system. In this system, a user 1 through an app 2 communicates over the Internet 20 with a remote database 110 containing sensor readings. The app 2 can run on a smart phone or a tablet or a computer, among others. The data from the internet 20 is provided to a natural language processing (NLP) layer 30. From layer 30, keywords are extracted by module 32, and provided to a chatbot or a chat engine 40. The chat engine communicates with a sensor database 110 and other home devices that can converse with the user using speech, for example. Data from the chat engine 40 and the Database 110 are observed and learned by the machine learning module 50. The database 110 receives sensor readings from a plurality of IOT devices 111 that contain a processor, a communication module such as Ethernet communication module or a Wi-Fi module or a Bluetooth module, for example.

The IOT devices 111 measure the environment that the plant lives in. For example, common types of environmental monitoring and control for plants incorporate a means of controlling the start time and duration of watering cycles via a central timing controller. The need to adjust a watering cycle due to the environmental influence is necessary in order to save natural resources, reduce costs, and to improve the growing environment for plants. Such environmental conditions include temperature changes, relative humidity, precipitation, wind and cloud cover. To illustrate, a soil moisture sensor is usually installed in the ground by boring of a precisely sized hole, placing the sensor at the appropriate depth to measure the soil properties in the root zone, placing a slurry of water and soil in the hole to assure that the sensor has good contact with the soil and try to restore the soil in the hole to its previous condition as much as possible so that the sensor provides readings that correctly reflect the state of the soil. If the soil is not restored properly, water and fertilizer can drain down along the hole to the sensor and corrupt the sensor readings. It is common for soil to be stratified into regions of varying textures, composition and drainage properties. Digging a hole and refilling it with slurry disrupts these strata around the sensor and decreases the accuracy of the sensor readings. As the soil cycles from wet to dry, the soil may shrink back from the sensor and loose contact. If this happens, the sensor can no longer read the soil status properly. Sometimes, rewetting the soil is not sufficient to restore the sensor contact and the sensor must be reinstalled. The wires that run from the sensors up through the soil to the surface are then routed either to a central controller directly or to a central controller through a wireless transmission system. This method is burdensome in time, tools required and is prone to unsuccessful installation through poor seating of the sensor in the soil, poor representation of the target soil by the sensed soil that was disturbed by installation, and electrical noise in connecting wires. The central controller receives the signals from the remote sensors and determines whether or not to start the next irrigation cycle for a particular irrigation zone.

The present disclosure contemplates any number of sensor mechanisms (e.g., ion, conductivity, moisture, temperature, etc.) configured into the sensor. For example, an ion detection sensor could be configured into the sensor to measure ion levels in the surrounding soil. Ion sensors could be configured from one or more ion sensitive materials, polymers, transducing materials, or the like. In one aspect, an ion sensitive field-effect transistor (ISFET) may be configured to measure ion concentration. In another aspect, ion-selective microelectrodes may be used to measure ion concentration. For measuring temperature an HFIC, discussed above, may be used. The HFIC chip may also include one or more connects for external capacitive and resistive sensors contemplated herein. In any case, the sensors may be configured using one or more biodegradable materials allowing the sensor to be left in the soil after deployment thereby keeping with the objectives of the present disclosure.

Other sensors can be pH sensors. Fluorescent indicators have been used as potentiometric techniques to measure pH. 8-Hydroxyl-1,3,6-pyrenetrisulphonate (HPTS) has been considered one of the best potential indicators for pH determination because of its excellent photo-stability, high quantum yield, dual excitation, large Stokes' shift and long fluorescence emission. An essential feature of this indicator is that the acidic (associated, HPTS) and basic (dissociated, PTS) forms have different excitation wavelengths at 405 and 450 nm, with an isosbestic point at 418 nm, but exhibit a similar fluorescence emission maximum at 515 nm. The dual excitation and single emission make HPTS suitable for ratiometric detection of pH. The fluorescence intensity at 406 nm for the acid form decreases but the intensity at 460 nm for the base form increases as the pH is raised accompanying the conversion of the acidic into basic forms of HPTS. However, when HPTS is directly physically or covalently immobilized in polymer membranes, researchers have found that the fluorescence excitation intensities of both acid and base forms increased along with increasing pH, and that there was no isosbestic point accompanying the conversion between acid and base form. This change results in a lowered sensitivity for ratiometric pH measurements.

In one embodiment, the app 2 communicates over the Internet 20 and accesses the DB 110 over a predetermined time interval (for example, every four or five hours) to collect plant data by a sensor in the IOT device 111. The sensor collects environmental parameters and sends text data and binary data periodically from the plant sites over the Internet for updating the data in the database 110. In one embodiment the sensor sends data compliant withan RSS (Rich Site Summary) reader. The RSS is a XML-based format for structuring and describing meta-data such as headlines and/or summaries of the web sites and is mainly used for publishing update information of the sites. Document described with the RSS includes a title, address, data captured, time of update and so on for each plant. The RSS data collected by the sensor are stored in the database 110, which is typically stored in a hard disk device. The database 110 can be searched with a search program or the chat engine or the learning machine using keywords. In one embodiment, the data base 110 is a conversation database, which stores a collection of “inquiries” and “responses” for general conversations. The database 110 also stores commands for instructing the sensors to respond in association with these “inquiries” and “responses”.

In one embodiment, the app is connected to a voice recognition engine such as the Google voice recognition system or Apple's Siri engine. The chat engine 40 analyzes the text data delivered from the voice recognition engine, searches either or both of the data base 110 and the chat engine 40 in accordance with the content of the received text data and selects the content that is appropriate for the response. Then, the text data of such selected content is delivered to a voice synthesizer, in which the text data are converted into voice signals. The voice signals generated by the voice synthesizer and/or the control signals for querying the sensor are transmitted to the app 2 over the Internet 20. The app 2 receives these voice signals and/or control signals and speak through a speaker (not shown) and/or recommends an action or response in accordance with the control signal.

A good growing environment is crucial to the health of plants. Various factors influence a healthy growth of a plant. The primary factors that influence the growth (and measured by the IOT sensors of FIG. 1) can be characterized as listed below:
1. Temperature & Humidity
2. Amount of Light
3. Nutrient Problems & Deficiencies
4. Air Circulation
5. Watering & Root PH
6. Preventing Bugs & Mold

Other factors that are measured by the sensor include fertilizer level. Macronutrient fertilizers are generally labeled with an NPK analysis, based on the relative content of the chemical elements nitrogen (N), phosphorus (P), and potassium (K) that are commonly used in fertilizers. The N value is the percentage of elemental nitrogen by weight in the fertilizer. The value for P is the fraction by weight of P2O5 in a fertilizer with the same amount of phosphorus that gets all of its phosphorus from P2O5. The value for K is analogous, based on a fertilizer with K2O.

For example, the fertilizer sylvite is a naturally occurring mineral consisting mostly of potassium chloride (KCl). As such, it contains one potassium atom for every chlorine atom, and is 52% potassium and 48% chlorine by weight (because of the difference in atomic weights of the elements). K2O is similarly 83% potassium. Therefore, a fertilizer that gets all its potassium from KCl would have to be 63% K2O (0.52/0.83 is 0.63). Pure KCl fertilizer would thus be labeled 0-0-63; because sylvite is less than pure (it contains other compounds that contain no potassium), it is labeled 0-0-60.

The above parameters are normally managed with the conventional knowledge & wisdom of the growers or in recent times through advanced automated solutions comprising of various electronic sensors strategically positioned to monitor & relay the above parameters in real-time to servers via internet & displayed on the screens of the growers. In contrast, the present system operates on a platform with IOT sensors and with the chat engine.

In one embodiment, chat engine 142 utilizes pattern matching engine or learning machine to recognize appropriate responses for input messages. In one embodiment, pattern matching engine employs AIML (Artificial Intelligence Markup Language), which is an XML dialect. Note that AIML implementation is used in one embodiment but other implementations are used as well. Here, AIML comprises several elements. A first is category, which is a fundamental unit of knowledge. A category includes two or more elements (e.g. pattern and template).

<category>
<pattern>WHAT IS SOIL CONDITION</pattern>
<template>The soil is acidic.</template>
</category>

When this category is loaded, a chatbot receiving an input “What is the soil condition” can respond with “The soil is acidic.” Here, a pattern is a string of characters that can match one or more user inputs. A pattern directed at a particular plant such as “What is your soil condition” matches only one input, whether upper or lower case. However, patterns can also contain wildcards; thus, “what is your *” can match many inputs such as “what is your objective,” what is your address,” etc.

A template provides the response for a pattern. An example of a template is—My soil is acidic. A template can also use variables. A template may be as simple as some literal text, like “My name is <chatbot name=“name”/>,” which substitutes the chatbot's name into the sentence, or “You said you are <get soil condition=”soil_pH“/>pH,” in which the plant's pH of the soil is replaced in the sentence.

Text formatting, conditional response (if then/else), and random responses are elements of templates. Templates can also use the srai element to redirect to another pattern.

Those skilled in the art will recognize that other techniques that can either substitute or supplement pattern matching engine can be employed. After pattern matching engine recognizes appropriate responses for input messages, pattern matching engine then passes the chatbot message to response generator, which generates an appropriate response.

The system uses one or more scripts to accomplish updates of output messages. As further discussed below, scripts are text files or database records that include chat session dialogue and instructions for chatbot system 108. A script typically consists of user messages responsive to the chatbot messages and chatbot messages responsive to the user messages. Scripts can store and display context information and the relationship between the input and output messages in a compact yet intuitive manner; users can easily and efficiently use scripts to update a message without updating other messages that use the updated message as context. In one embodiment, the scripts are not a “knowledge base” that the chatbot engine can use directly. They are media that bridge front end (all training features) and the back end (the chatbot engine). Users can enter input/output messages as desired. As the context information and relationship between the messages are kept and displayed in a compact yet intuitive manner, users can easily and efficient work with the scripts, without worrying about the inconsistency. When users want to add a new input when there is no existing output message, they create another new script. When users delete an input or output message from the script, system deletes all of its children and children of children, or asks users whether they want to move the children as the new children of other messages or to a new script.

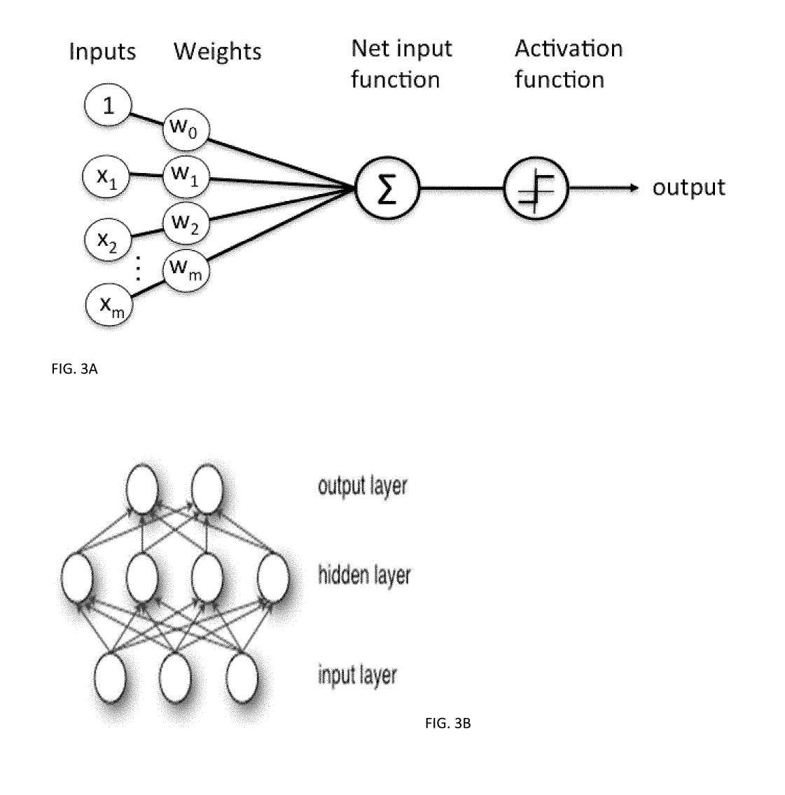

FIG. 3A-3B show an exemplary learning machine. For example, the exemplary learning machine can detect conditions of a plant and to recommend actions for the plant. The learning machine can also learn from the interactions between the user and the DB query/answer and generate a new script that is responsive to future inquires based on prior inquiries. In one embodiment, the learning machine can be a deep learning machine. Deep learning is the name for “stacked neural networks”; that is, networks composed of several layers. The layers are made of nodes. A node is just a place where computation happens, loosely patterned on a neuron in the human brain, which fires when it encounters sufficient stimuli. A node combines input from the data with a set of coefficients, or weights, that either amplify or dampen that input, thereby assigning significance to inputs for the task the algorithm is trying to learn. (For example, which input is most helpful is classifying data without error?) These input-weight products are summed and the sum is passed through a node's so-called activation function, to determine whether and to what extent that signal progresses further through the network to affect the ultimate outcome, say, an act of classification.

A node layer is a row of those neuronlike switches that turn on or off as the input is fed through the net. Each layer's output is simultaneously the subsequent layer's input, starting from an initial input layer receiving your data. Pairing adjustable weights with input features is how we assign significance to those features with regard to how the network classifies and dusters input.

Deep-learning networks are distinguished from the more commonplace single-hidden-layer neural networks by their depth; that is, the number of node layers through which data passes in a multistep process of pattern recognition.

Earlier versions of neural networks such as the first perceptrons were shadow, composed of one input and one output layer, and at most one hidden layer in between. More than three layers (including input and output) qualifies as “deep” learning. So deep is a strictly defined, technical term that means more than one hidden layer.

In deep-learning networks, each layer of nodes trains on a distinct set of features based on the previous layer's output. The more layers in the neural net, the more complex the features your nodes can recognize, since they aggregate and recombine features from the previous layer.

his is known as feature hierarchy, and it is a hierarchy of increasing complexity and abstraction. It makes deep-learning networks capable of handling very large, high-dimensional data sets with billions of parameters that pass through nonlinear functions.

Above all, these nets are capable of discovering latent structures within unlabeled, unstructured data, which is the vast majority of data in the world. Another word for unstructured data is raw media; i.e. pictures, texts, video and audio recordings. Therefore, one of the problems deep learning solves best is in processing and clustering the world's raw, unlabeled media, discerning similarities and anomalies in data that no human has organized in a relational database or ever put a name to.

For example, deep learning can take a million images, and cluster them according to their similarities: cats in one corner, ice breakers in another, and in a third all the photos of your grandmother. This is the basis of so-called smart photo albums.

Now apply that same idea to other data types: Deep learning might duster raw text such as emails or news articles. Emails full of angry complaints might duster in one corner of the vector space, while satisfied customers, or spambot messages, might duster in others. This is the basis of various messaging filters, and can he used in customer-relationship management (CRM). The same applies to voice messages. With time series, data might duster around normal/healthy behavior and anomalous/dangerous behavior. If the time series data is being generated by a smart phone, it will provide insight into users' health and habits; if it is being generated by an autopart, it might be used to prevent catastrophic breakdowns.

Deep-learning networks perform automatic feature extraction without human intervention, unlike most traditional machine-learning algorithms. Given that feature extraction is a task that can take teams of data scientists years to accomplish, deep learning is a way to circumvent the chokepoint of limited experts. It augments the powers of small data science teams, which by their nature do not scale.

When training on unlabeled data, each node layer in a deep network learns features automatically by repeatedly trying to reconstruct the input from which it draws its samples, attempting to minimize the difference between the network's guesses and the probability distribution of the input data itself. Restricted Boltzmann machines, for examples, create so-called reconstructions in this manner.

In the process, these networks learn to recognize correlations between certain relevant features and optimal results—they draw connections between feature signals and what those features represent, whether it be a full reconstruction, or with labeled data.

A deep-learning network trained on labeled data can then be applied to unstructured data, giving it access to much more input than machine-learning nets. This is a recipe for higher performance: the more data a net can train on, the more accurate it is likely to be. (Bad algorithms trained on lots of data can outperform good algorithms trained on very little.) Deep learning's ability to process and learn from huge quantities of unlabeled data give it a distinct advantage over previous algorithms.

Deep-learning networks end in an output layer: a logistic, or softmax, classifier that assigns a likelihood to a particular outcome or label. We call that predictive, but it is predictive in a broad sense. Given raw data in the form of an image, a deep-learning network may decide, for example, that the input data is 90 percent likely to represent a person.

Our goal in using a neural net is to arrive at the point of least error as fast as possible. We are running a race, and the race is around a track, so we pass the same points repeatedly in a loop. The starting line for the race is the state in which our weights are initialized, and the finish line is the state of those parameters when they are capable of producing accurate classifications and predictions.

The race itself involves many steps, and each of those steps resembles the steps before and after. Just like a runner, we will engage in a repetitive act over and over to arrive at the finish. Each step for a neural network involves a guess, an error measurement and a slight update in its weights, an incremental adjustment to the coefficients.

A collection of weights, whether they are in their start or end state, is also called a model, because it is an attempt to model data's relationship to ground-truth labels, to grasp the data's structure. Models normally start out bad and end up less bad, changing over time as the neural network updates its parameters.

This is because a neural network is born in ignorance. It does not know which weights and biases will translate the input best to make the correct guesses. It has to start out with a guess, and then try to make better guesses sequentially as it learns from its mistakes.

Here is a simple explanation of what happens during learning with a feedforward neural network, the simplest architecture to explain.

Input enters the network. The coefficients, or weights, map that input to a set of guesses the network makes at the end.

input*weight=guess

Weighted input results in a guess about what that input is. The neural then takes its guess and compares it to a ground-truth about the data, effectively asking an expert “Did I get this right?”

ground truth−guess=error

The difference between the network's guess and the ground truth is its error. The network measures that error, and walks the error back over its model, adjusting weights to the extent that they contributed to the error.

error*weight's contribution to error=adjustment

The three pseudo-mathematical formulas above account for the three key functions of neural networks: scoring input, calculating loss and applying an update to the model—to begin the three-step process over again. A neural network is a corrective feedback loop, rewarding weights that support its correct guesses, and punishing weights that lead it to err.

The neural network can be viewed as a linear regression machine. In its simplest form, linear regression is expressed as

Y_hat=bX+a

where Y_hat is the estimated output, X is the input, b is the slope and a is the intercept of a line on the vertical axis of a two-dimensional graph. (To make this more concrete: X could be radiation exposure and Y could be the crop failure; X can be the amount of fertilizer and Y the size of the crop.)

The next step is to imagine multiple linear regression, where many input variables produce an output variable. It's typically expressed like this:

Y_hat=b_1*X_1+b_2*X_2+b_3*X_3+a

Now, that form of multiple linear regression is happening at every node of a neural network. For each node of a single layer, input from each node of the previous layer is recombined with input from every other node. That is, the inputs are mixed in different proportions, according to their coefficients, which are different leading into each node of the subsequent layer. In this way, a net tests which combination of input is significant as it tries to reduce error.

Once the system sums your node inputs to arrive at Y_hat, it's passed through a non-linear function. Here's why: If every node merely performed multiple linear regression, Y_h a t would increase linearly and without limit as the X's increase, but that doesn't suit the purposes.

The nonlinear transforms at each node are usually s-shaped functions similar to logistic regression. They go by the names of sigmoid (the Greek word for “S”), tanh, hard tanh, etc., and they shaping the output of each node. The output of all nodes, each squashed into an s-shaped space between 0 and 1, is then passed as input to the next layer in a feed forward neural network, and so on until the signal reaches the final layer of the net, where decisions are made.

The name for one commonly used optimization function that adjusts weights according to the error they caused is called “gradient descent”. Gradient is another word for slope, and slope, in its typical form on an x-y graph, represents how two variables relate to each other: rise over run, the change in money over the change in time, etc. In this particular case, the slope we care about describes the relationship between the network's error and a single weight; i.e. that is, how does the error vary as the weight is adjusted.

To put a finer point on it, which weight will produce the least error? Which one correctly represents the signals contained in the input data, and translates them to a correct classification? Which one can hear “nose” in an input image, and know that should be labeled as a face and not a frying pan?

As a neural network learns, it slowly adjusts many weights so that they can map signal to meaning correctly. The relationship between network Error and each of those weights is a derivative, dE/dw, that measures the degree to which a slight change in a weight causes a slight change in the error.

Each weight is just one factor in a deep network that involves many transforms; the signal of the weight passes through activations and sums over several layers, so we use the chain rule of calculus to march back through the networks activations and outputs and finally arrive at the weight in question, and its relationship to overall error.

The chain rule in calculus states that

$$\frac{dz}{dϰ} = \frac{dz}{dy} \cdot \frac{dy}{dϰ} .$$

In a feedforward network, the relationship between the net's error and a single weight will look something like this:

$$\frac{d Error}{d weight} = \frac{d Error}{d activation} * \frac{d activation}{d weight}$$

That is, given two variables, Error and weight, that are mediated by a third variable, activation, through which the weight is passed how a change in weight affects a change in Error can be determined by first calculating how a change in activation affects a change in Error, and how a change in weight affects a change in activation.

Along with a FAQ table that's pre-trained on the system, the system learns to answer relevant questions to the specific sub-domain and with the help of the machine learning component, it has the ability to answer questions it has never seen before with a high accuracy. Chat engine can not only communicate with the pre-existing app that comes along with the IOT device, it can also communicate and share information with third party home voice assistants such as the Google Home assistant or Amazon Alexa. This broadens the interaction spectrum of the user with the system by allowing the user to communicate with any given component at any time. The system can also handle scaling across multiple IOT devices, so readings from new devices on the network can benefit from previously learned information for providing the user/grower with optimal growth conditions alerts & notifications automatically or on-request from the chatbot.

FIG. 2 shows exemplary Growth Parameters representation in the information database. The database 110 contains exemplary sensor reads on the plant environment including soil temperature, moisture, carbon dioxide level, and light, for example.

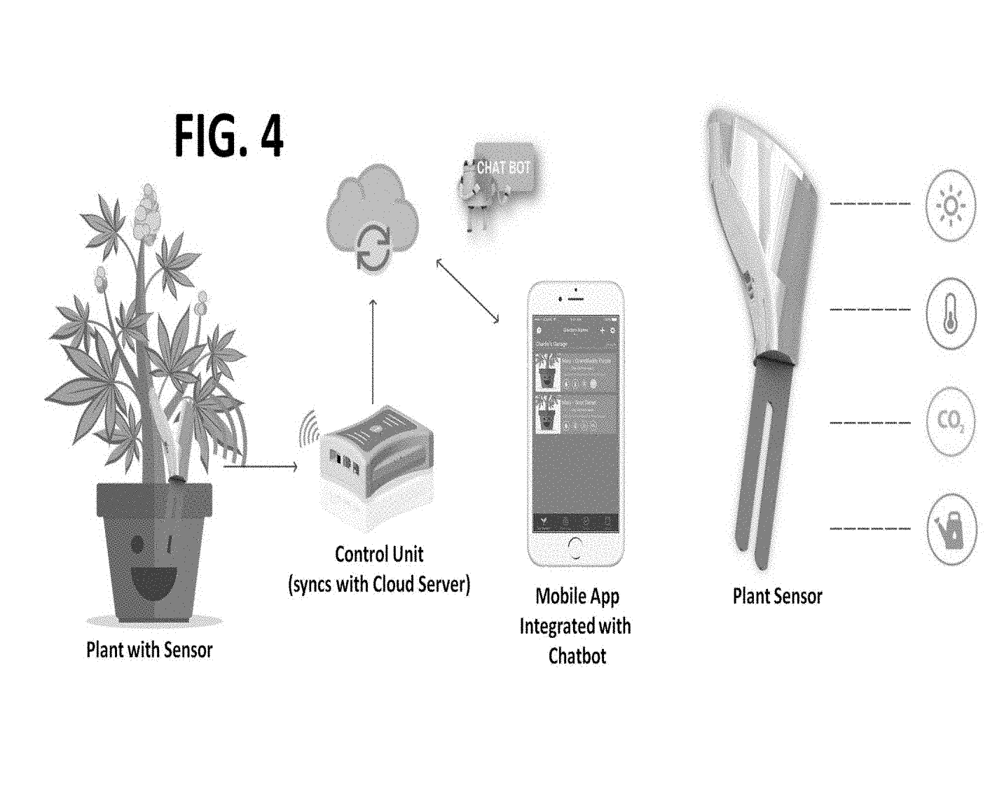

FIG. 4 shows an exemplary chatbox arrangement where a plant receives a plant sensor. The plant sensor wirelessly communicates with a control unit that in turn syncs with the cloud server. A mobile device such as a smart phone and mobile app communicates with the cloud to receive the chatbot communications. The chatbot engages customers pro-actively with the platform & product and provides a personalized experience based on previous interactions. The chatbot can gather and analyze customer feedback and provides expert system knowledge with minimal HITL.

The plant sensor has a Transmitter Module that is a Rugged Light Weight Sensor Module and has higher battery life with single AA Battery. The wireless module can be a Bluetooth4.1 BLE Interface for Node to Controller connectivity. The plant sensor has Integrated Light, Temperature and Soil moisture sensor and a Battery State-of-Charge (SoC) indicator. The plant sensor communicates with the Controller, which is a Compact module with multi-node sensor connectivity. The unit has an Ambient CO2 integrated sensor & integrated Wi-Fi and Multi-connectivity interfaces (future ready)). The unit offers Time based data reception and Cloud computing with a Provision for local data storage.

By instantaneously analyzing a customer's prior communications and leveraging real-time linguistic analysis, the system could personalize Al communication for customers via online chat screens, in automated contact centers, through voice enabled devices and even with video formats.

In addition to learning from the numeric data specific to a IOT device, the learning system can also make suggestions for optimal growth. The system is not limited to recommendations on soil. For example, in hydroponic gardening, a factor is Temperature. Plants grow well only within a limited temperature range. Temperatures that are too high or too low will result in abnormal development and reduced production. Warm-season vegetables and most flowers grow best between 60° and 75° or 80° F. Cool-season vegetables such as lettuce and spinach should be grown between 50° and 70° F.

Another factor considered by the learning system is Light. All vegetable plants and many flowers require large amounts of sunlight. Hydroponically grown vegetables like those grown in a garden, need at least 8 to 10 hours of direct sunlight each day to produce wells Artificial lighting is a poor substitute for sunshine, as most indoor lights do not provide enough intensity to produce a crop. Incandescent lamps supplemented with sunshine or special plant-growth lamps can be used to grow transplants but are not adequate to grow the crop to maturity. High intensity lamps such as high-pressure sodium lamps can provide more than 1,000 foot-candles of light. The serious hobbyist can use these lamps successfully in areas where sunlight is inadequate. The fixtures and lamps, however, are very expensive and thus not feasible for a commercial operation.

Adequate spacing between plants will ensure that each plant receives sufficient light in the greenhouse. Tomato plants pruned to a single stem should be allowed 4 square feet per plant. European seedless cucumbers should be allowed 7 to 9 square feet, and seeded cucumbers need about 7 square feet. Leaf lettuce plants should be spaced 7 to 9 inches apart within the row and 9 inches between rows. Most other vegetables and flowers should be grown at the same spacing as recommended for a garden.

Greenhouse vegetables, whether grown in soil or in a hydroponic system, will not do as well during the winter as in the summer. Shorter days and cloudy weather reduce the light intensity and thus limit production. Most vegetables will do better if grown from January to June or from July to December than if they are started in the fall and grown through the midwinter months.

The learning system can recommend changes in Water. Providing the plants with an adequate amount of water is not difficult in the water culture system, but it can be a problem with the aggregate culture method. During the hot summer months a large tomato plant may use one-half gallon of water per day. If the aggregate is not kept sufficiently moist, the plant roots will dry out and some will die. Even after the proper moisture level has been restored, the plants will recover slowly and production will be reduced. Water quality can be a problem in hydroponic systems. Water with excessive alkalinity or salt content can result in a nutrient imbalance and poor plant growth. Softened water may contain harmful amounts of sodium. Water that tests high in total salts should not be used. Salt levels greater than 0.5 millions or 320 parts per million are likely to cause an imbalance of nutrients. The amateur chemist may be able to overcome this problem by custom mixing the nutrient solutions to compensate for the salts in the water.

The system can determine optimal Oxygen. Plants require oxygen for respiration to carry out their functions of water and nutrient uptake. In soil adequate oxygen is usually available, but plant roots growing in water will quickly exhaust the supply of dissolved oxygen and can be damaged or killed unless additional air is provided. A common method of supplying oxygen is to bubble air through the solution. It is not usually necessary to provide supplementary oxygen in aeroponic or continuous flow systems.

Other optimization to be recommended by the learning system includes Mineral Nutrients. Green plants must absorb certain minerals through their roots to survive. In the garden these minerals are supplied by the soil and by the addition of fertilizers such as manure, compost, and fertilizer salts. The essential elements needed in large quantities are nitrogen, phosphorus, potassium, calcium, magnesium, and sulfur. Micronutrients—iron, manganese, boron, zinc, copper, molybdenum, and chlorine are also needed but in very small amounts.

The system can recommend changes in Support. In a garden the plant roots are surrounded by soil that supports the growing plant. A hydroponically grown plant must be artificially supported, usually with string or stakes.

This type of system can also give general question answers to frequently asked user questions about the state of the system. The model developed in this system can also connect to various voice enabled devices like Google Home or Amazon Alexa to feed and retrieve information from the IoT device database. The chatbot scales across readings from multiple IOT devices and can intelligently decompose the data from all the devices to make future predictions. This chatbot scales across readings from multiple IOT devices and can intelligently decompose the data from all the devices to make future predictions. One or more reports summarizing the conversations between the chatbot and one or more correspondents. The reports may include one or more of:
statistics about the number of nodes selected for processing;
statistics about the number of times each node was selected for processing;
the exact words used in correspondents input messages;
the number of input messages that matched to the default node;
which nodes have been selected by a correspondent after a fuzzy search has been performed and the input messages that have been associated with the node as a result; profile reports on individual correspondents, groups of correspondents, and nodes in the conversation data structure;
the number of times correspondents engaged in specific processes with the chatbot;
the number of times correspondents completed certain processes with the chatbot, in combination with reports about various profile variables
statistics about the number of input and output messages;
statistics about the number of conversations; and
statistics about time spent in conversation.

Advantageously, the chatbot described here functions with more human-like intelligence. For example, if the correspondent asks a question that cannot be matched to a known question, or asks an ambiguous question, the chatbot can perform a search for the closest ranking match and present the answer to the correspondent, or autonomously decide on the best answer using a detailed profile of the correspondent. The chatbot described here can also direct the correspondent down a long conversation path with conditional branching, not just simple answer to known correspondent question. The chatbot has to interpret the question, draw conclusions about the correspondent's intentions, or react interactively to elicit more information until enough information has been assembled for it to answer.

The chatbot offers way to tailor the information to suit the correspondent, and provides a mechanism for dynamically responding to in-depth information about correspondents' behavior, intentions and interests and other profile characteristics. The chatbot described here provides mechanisms that enable the tailoring of the chatbot's responses depending on information gathered about the correspondent, so that the conversation is highly personalized. The chatbot described here also provides a mechanism for detailed reporting about a correspondent using information gathered during a conversation.

It will be appreciated by persons skilled in the art that numerous variations and/or modifications may be made to the invention as shown in the specific embodiment without departing from the scope of the invention as broadly described. The present embodiments are, therefore, to be considered in all respects as illustrative and not restrictive.

For example, the chatbot functionality is not limited to the FAQ space and can be applied in many other contexts. For instance, the chatbot may be associated with an avatar in a virtual world and used to engage in conversations with real people or other avatars in the virtual world, or they may be present in a personal companion robot, or a machine or mobile device.

The present invention as discussed herein has been described in reference to a conversational and synthetic character interface. However, the present invention may be applied to numerous conversational or synthetic characters concurrently in a same interface. In addition, the teachings of the present invention apply to any type of animated interface or presentation device (virtual classroom instructor, or tutor, for example) or other animated devices or icons. The present invention may be used as a computer interface or for directing operations of any type of equipment of varying configurations (televisions, VCR's, stereos, to figures, radar devices, mechanical equipment such as heavy machinery, and building management/maintenance devices as just a few examples).

This detailed description includes example portions of code. However, the example portions of code are not intended to be either a compilable or executable program or program design language or contain all the features discussed herein, but are merely illustrative of techniques described herein and provided as examples.

The present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMS, microdrive, and magneto-optical disks, ROMs, RAMs, EPROMs, EEPROMs, DRAMs, VRAMS, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the processing of the present invention. Such software may include, but is not limited to, device drivers, peripheral equipment programs, operating systems, and user applications. Ultimately, such computer readable media further includes software for performing the functions of the present invention as described above.

Included in the programming (software) of the general/specialized computer or microprocessor are software modules for implementing the teachings of the present invention, including, but not limited to, input and identification of user inputs, deliberative and reactive processing, retrieval of knowledge and discourse models, scheduling of actions in response to the inputs and other processing, and implementing the actions scheduled via movements and speech of a synthetic character or other animation.

The description above is largely directed to exemplary embodiments of the invention. Specificity of language and statements of advantageous performance in this specification do not imply any commensurate limitation on the scope of the invention, nor do they require the stated performance. Thus no one embodiment disclosed herein is essential to the practice of another unless indicated as such. Indeed, the invention, as supported by the disclosure including specification, claims, abstract of the disclosure, and figures provided, includes all systems and methods that can be practiced from all suitable combinations of the various aspects disclosed, and all suitable combinations of the exemplary elements listed. Such combinations have particular advantages, including advantages not specifically recited herein.

Alterations and permutations of the proffered embodiments and methods will become apparent to those skilled in the art upon review of the specification, claims and drawings. Although the disclosed system is particularly suitable for analysis and improvement of plant growing and farming applications, variations can be implemented, for example, for analysis and improvement of other applications, such as to diagnose and recommend improvements in games, sports, or physical therapy. Accordingly, none of the disclosure of the embodiments and methods constrains the scope of the invention. Rather, the claims issuing hereon or on one or more applications claiming benefit of this application or the applications to which it claims priority will variously define the invention.

What is claimed is:

1. A method to identify plant growth conditions, comprising:
providing an internet of thing (IOT) connected sensor to capture one or more plant conditions;
communicating the plant conditions to a remote data storage device to store current and previous local data independent of outside sources;
receiving a user inquiry about the plant condition in a natural language;
providing the query to a chatbot; and
answering the query using the chatbot.

2. The method of claim 1, wherein the user query is verbal.

3. The method of claim 2, comprising converting the verbal query to text.

4. The method of claim 1, wherein the user query is natural language text.

5. The method of claim 1, comprising applying a natural language parser (NLP) to user text.

6. The method of claim 1, comprising extracting keywords from a user text.

7. The method of claim 1, wherein the remote storage devices comprises a database, further comprising applying machine learning to data in a database and the chatbot.

8. The method of claim 1, wherein the IOT device comprises a processor and a transceiver to communicate with the remote data storage device.

9. The method of claim 1, wherein the sensor captures one or more of: soil temperature, ambient temperature, soil pH condition, soil nitrogen level, soil fertilizer condition, soil nitrogen, phosphorous, and potassium (NPK) level.

10. The method of claim 1, comprising analyzing a customer's prior communications using machine learning and applying real-time linguistic analysis.

11. The method of claim 1, comprising personalizing communication to a user with an online chat screens

12. The method of claim 1, comprising personalizing communication with a user in automated contact centers or voice enabled devices.

13. The method of claim 1, comprising learning from the numeric data specific to a IOT device, and providing user suggestions for plant growth.

14. The method of claim 1, comprising providing answers to frequently asked user questions about the plant condition.

15. The method of claim 1, comprising connecting to a voice enabled device to retrieve data from the data storage device.

16. The method of claim 1, comprising identifying ideal plant growth conditions based on the IOT connected sensor using previous local data that is independent of outside sources.

17. The method of claim 1, comprising accumulating readings from multiple IOT sensors and using data from all sensors to make future predictions.

18. A plant monitoring system, comprising:
one or more internet of things (IOT) sensors to detect conditions associated with a plant;
a database coupled to the sensors; and
a chatbot coupled to the database to answer queries from a user about the plant condition.

19. The system of claim 17, wherein the IOT device comprises a processor and a transceiver to communicate with the remote data storage device

20. The system of claim 17, wherein the sensor captures one or more of: soil temperature, ambient temperature, soil pH condition, soil nitrogen level, soil fertilizer condition, soil nitrogen, phosphorous, and potassium (NPK) level.
